(19) United States
(12) Patent Application Publication
(10) Pub. No.: US 2007/0075820 A1
(43) Pub. Date: Apr. 5, 2007

(54) Core structure and manufacturing method of inductor

(75) Inventors: Zxing Liu, Taoyuan Hsien (TW); Siyzh Fan, Taoyuan Hsien (TW); Rock Tang, Taoyuan Hsien (TW); Ching-Sung Kung, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/448,820

(22) Filed: Jun. 8, 2006

(30) Foreign Application Priority Data
Sep. 30, 2005 (TW) 94134266

(51) Int. Cl. H01F 27/30

(52) U.S. Cl. 336/208

(57) ABSTRACT

An inductor with a core structure is capable of providing a continuous magnetic path. The inductor includes at least one bobbin and a core structure, coupled to the bobbin, wherein the core structure is formed by rolling at least one longitudinal element. Also, a method for manufacturing the core structure includes steps of: providing at least one longitudinal element, rolling the longitudinal element into a block, dividing the block into a pair of half core structures, and sintering the half core structures.

### CROSS REFERENCE TO RELATED APPLICATIONS

This Non-provisional application claims priority under U.S.C. § 119(a) on patent application Ser. No(s). 094134266, filed in Taiwan, Republic of China on Sep. 30, 2005, the entire contents of which are hereby incorporated by reference.

### BACKGROUND OF THE INVENTION

1. Field of the Invention

The invention relates to a core structure, and in particular to a core structure of an inductor and a manufacturing method thereof.

2. Description of the Related Art

Generally, a high power passive switched power system has to be equipped with a power factor correction (PFC) inductor so as to correct power factors in a circuit thereof.

An inductor is a structure consisted of enamel wires, a bobbin, and a core. The core is manufactured by a stamping longitudinal silicon-steel strap into a silicon-steel sheet, and then several silicon-steel sheets are uniformly inserted into the bobbin with enamel wires wound therearound.

FIG. 1 shows a conventional inductor 100, which includes a set of bobbins 110 and a plurality of silicon-steel sheets 120. When the inductor 100 is assembled, the silicon-steel sheets 120 have to be stacked to a predetermined thickness and then the silicon-steel sheets 120 are installed into the bobbins 110. If negligence occurs in the stacking procedure, the silicon-steel sheets are deformed and discarded.

Additionally, because the conventional silicon-steel sheets 120 of the inductor 100 form a non-continuous magnetic path, this generates magnetic interference with surrounding electronic devices. Also, the conventional inductor is complex to manufacture and difficult to assemble, having low reliability, and may cause failure in final products. In the manufacturing process, silicon-steel sheet stacking requires effort and increased costs. Therefore, it is necessary to provide an inductor with increased power, improved reliability with no increase in size, providing reduces noise and inductance deviation.

### BRIEF SUMMARY OF THE INVENTION

The invention provides an inductor including at least one bobbin and a core structure coupled to the bobbin. The bobbin comprises two sub-bobbins.

The core structure is formed by rolling a uniformly flat longitudinal element. The longitudinal element is made of silicon-steel or other metal materials. The longitudinal element is rolled into a block, sintered, and divided into a pair of half core structures. The half core structures are annealed and assembled with pre-coiled sub-bobbins to accomplish the assembly of the inductor.

According to a method for manufacturing the core structure of the invention, at least one longitudinal element is provided, which is made of silicon-steel or metal. The longitudinal element is rolled in a single direction to form a core structure, which is rolled in a shield and uniformly stacked form. The core structure is a closed block or rounded U-shaped structure. The size and the shape of the core structure can be modified. The block is sintered, and divided into a pair of half core structures. Finally, the half core structures are annealed and assembled with the sub-bobbins.

According to the inductor, the core structure and manufacturing method of the invention provides the core structure directly assembled after sintering and dividing. The core structure is manufactured without molding, such that size thereof can be modified. The core structure is formed by rolling a single longitudinal element, which forms a continuous magnetic path. The inductance and power of the inductor are increased, magnetic leakage is reduced, and magnetic interference with surrounding electronic devices is removed.

According to the inductor, the core structure and manufacturing method of the invention provides the core structure which can be assembled simply by assembling the divided half core structures and the bobbin. There is no requirement for manual assembly of silicon-steel sheets. As the result, the manufacturing processes of the inductor are simplified, and manufacturing time thereof shortened. The core structure of the invention utilizes less electromagnetic steel, and manufacturing cost is thus reduced.

In addition, the performance of an electronic apparatus utilizing the core structure of the invention is improved, magnetic leakage is reduced, and magnetic interference with surrounding electronic devices is removed. Further, the core structure is stable, material waste is reduced, and the reliability of the final produce is improved.

### BRIEF DESCRIPTION OF THE DRAWINGS

The invention can be more fully understood by reading the subsequent detailed description and examples with references made to the accompanying drawings, wherein:

FIG. 1 shows a conventional inductor; and

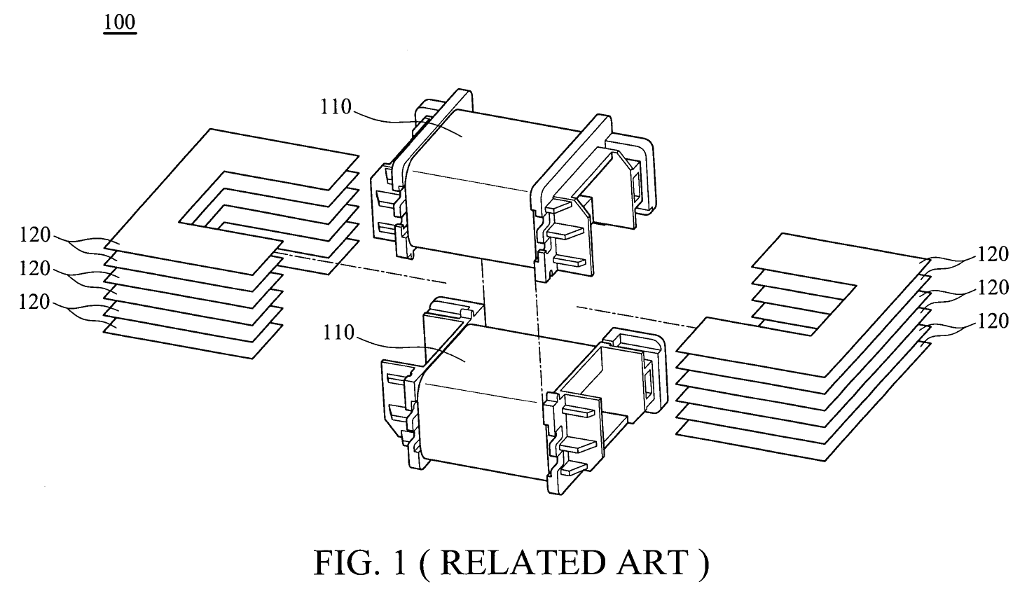

FIG. 2 shows an inductor and the core structure thereof according the preferred embodiment of the present invention.

### DETAILED DESCRIPTION OF THE INVENTION

A detailed description is given in the following embodiments with reference to the accompanying drawings.

The following description is of the best-contemplated mode of carrying out the invention. This description is made for the purpose of illustrating the general principles of the invention and should not be taken in a limiting sense. The scope of the invention is best determined by reference to the appended claims.

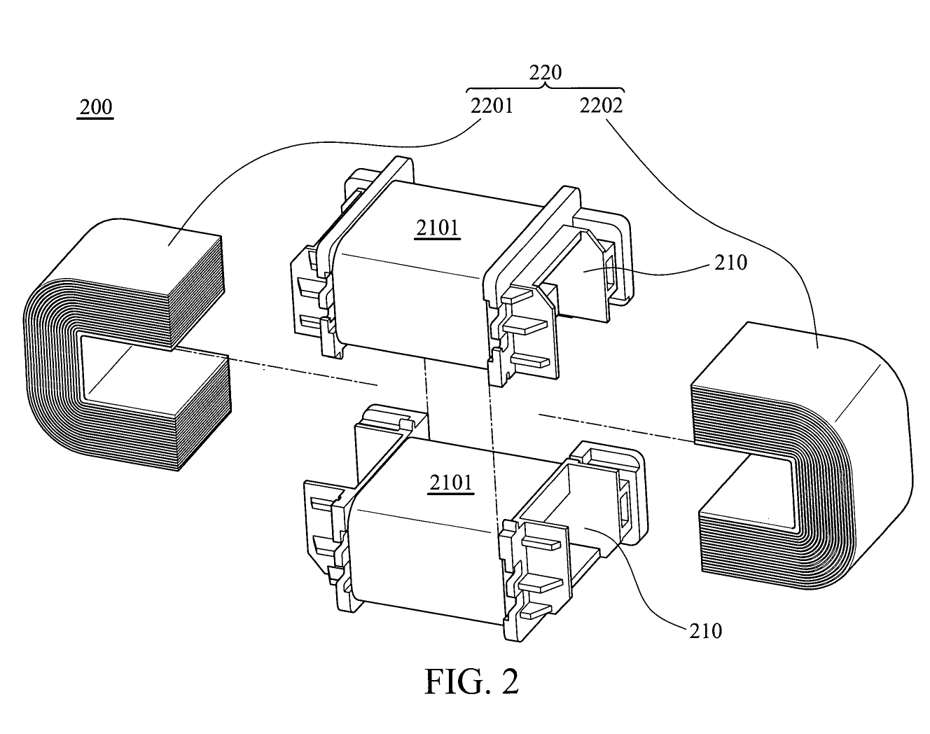

FIG. 2 shows an inductor 200 according the preferred embodiment of the present invention. The inductor 200 includes at least one bobbin 210 and a core structure 220 coupled to the bobbin 210. The bobbin 210 preferably has a pair of sub-bobbins 2101.

The core structure 220 is formed by rolling at least one longitudinal element. The longitudinal element is made of silicon-steel or other metal materials. Several longitudinal elements can be rolled into a block, sintered, and then divided into a pair of half core structures 2201 and 2202. The half core structures 2201 and 2202 are annealed and assembled with pre-coiled (not shown) sub-bobbins 2101 to accomplish the assembly of the inductor 200.

Also, a method for manufacturing the core structure is disclosed in the following description. Firstly, at least one longitudinal element is provided, which is made of silicon-steel or other metal materials. The longitudinal elements are rolled in a single direction to form a core structure, and the longitudinal elements can be rolled in a shield and uniformly stacked form. The size and the shape of the longitudinal elements can be modified. Then, the longitudinal elements are sintered in high temperature with protection of inert gas, and then the longitudinal elements are divided into a pair of half core structures. Finally, the half core structures are annealed and assembled with the sub-bobbins. The core structure can be a closed block or rounded U-shaped structure.

According to the inductor, the core structure is directly assembled after sintering and dividing. As the result, the core structure is manufactured without molding, such that the size and the shape thereof can be modified as requirements so as to provide convenience for users.

The core structure is formed by rolling at lease one single longitudinal element, which can form a continuous magnetic path. Further, the inductance and power of the inductor are increased, magnetic leakage is reduced, and magnetic interference with surrounding electronic devices is removed.

According to the inductor, the core structure and manufacturing method of the invention provides the core structure which can be assembled simply by assembling the divided half core structures and the bobbin. There is no requirement for manual assembly of silicon-steel sheets. As the result, the manufacturing processes of the inductor are simplified, and manufacturing time thereof shortened. The core structure of the invention utilizes less electromagnetic steel, and manufacturing cost is thus reduced.

In addition, the performance of an electronic apparatus utilizing the core structure of the invention is improved, magnetic leakage is reduced, and magnetic interference with surrounding electronic devices is removed. Further, the core structure is stable, material waste is reduced, and the reliability of the final produce is improved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for manufacturing a core structure, comprising steps of:
providing at least one longitudinal element;
rolling the longitudinal element into a block for serving as the core structure; and dividing the core structure into a pair of core parts.

2. The method as claimed in claim 1, wherein the longitudinal element comprises silicon-steel or other metal materials.

3. The method as claimed in claim 1, wherein the longitudinal elements are rolled in a single direction.

4. The method as claimed in claim 1, wherein the longitudinal elements are rolled in a shield form or in a stacked form.

5. The method as claimed in claim 1, wherein the longitudinal elements are substantially uniformly arranged.

6. Wherein the core structure is a closed or circular structure.

7. The method as claimed in claim 1, wherein each of the core parts is a U-shaped structure.

8. The method as claimed in claim 1, further comprising steps of:
sintering the core structure.

9. The method as claimed in claim 8, further comprising a step of:
annealing the core parts.

10. An inductor, comprising:
at least one bobbin; and
a core structure coupled to the bobbin, wherein the core structure is formed by rolling at least one longitudinal element into a block and dividing the block into a pair of core parts.

11. The inductor as claimed in claim 10, wherein the longitudinal element comprises silicon-steel or other metal materials.

12. The inductor as claimed in claim 10, wherein the longitudinal element comprises silicon-steel or other metal materials.

13. The inductor as claimed in claim 10, wherein the longitudinal elements are rolled in a shield form or in a stacked form.

14. The inductor as claimed in claim 10, wherein the longitudinal elements are substantially uniformly arranged.

15. The inductor as claimed in claim 10, wherein the core structure is a closed or circular structure.

16. The inductor as claimed in claim 10, wherein each of the core parts is a U-shaped structure.

17. The inductor as claimed in claim 10, wherein the core structure is formed by rolling the longitudinal element into the block, sintering the block, dividing the block into the pair of core parts, and annealing the core parts.

18. The inductor as claimed in claim 10, wherein the bobbin comprises two sub-bobbins.

19. The inductor as claimed in claim 10, further comprising a coil wound around the bobbin.
